(19) United States
(12) Patent Application Publication
(10) Pub. No.: US 2017/0005712 A1
(43) Pub. Date: Jan. 5, 2017

(54) METHOD AND APPARATUS FOR CHANNEL MEASUREMENT AND FEEDBACK

(71) Applicant: NEC CORPORATION, Tokyo (JP)

(72) Inventors: Chuangxin JIANG, Beijing (CN); Chaofeng LI, Beijing (CN); Ming LEI, Beijing (CN)

(73) Assignee: NEC CORPORATION, Tokyo (JP)

(21) Appl. No.: 15/113,183

(22) PCT Filed: Jan. 22, 2014
(86) PCT No.: PCT/CN2014/071140

§ 371 Date: Jul. 21, 2016

(51) Int. Cl. H04B 7/06; H04B 7/04; H04L 5/00

(52) U.S. Cl. CPC H04B 7/0626; H04B 7/0639; H04L 5/0055; H04B 7/0684; H04B 7/0413; H04W 88/02

(57) ABSTRACT

Embodiments of the invention provide a method for channel measurement and feedback. The method comprises transmitting a first CSI-RS and a second CSI-RS to a user equipment for vertical CSI measurement, wherein the first CSI-RS is based on antenna configuration of one vertical antenna element mapping to one vertical antenna port, and the second CSI-RS is based on antenna configuration of multiple vertical antenna elements mapping to one vertical antenna port. The method also comprises receiving at least one PMI fed back by the user equipment in accordance with the first CSI-RS and the second CSI-RS. The method further comprises determining a vertical precoding matrix for data transmission based on the at least one PMI.

### FIELD OF THE INVENTION

Embodiments of the present invention generally relate to wireless communication. More particularly, embodiments of the present invention relate to a method and apparatus for channel measurement and feedback in a MIMO System.

### BACKGROUND OF THE INVENTION

Multiple-input multiple-output (MIMO) is a key feature of Long Term Evaluation (LTE)/LTE-Advanced system. Currently, one-dimensional (horizontal) antenna array can provide flexible beam adaption in the azimuth domain through the horizontal precoding process. In vertical direction, fixed down-tilt is applied. It has been recently found that the full MIMO capability in full dimensional MIMO (3D MIMO) system with 2D antenna array can be is exploited through leveraging the two dimensional antenna planar such that the UE-specific elevation beamforming and spatial multiplexing on the vertical domain are also possible.

In order to achieving UE-specific beamforming and spatial multiplexing in elevation domain, a vertical precoding process is needed. Then, by combing the horizontal precoding process with the vertical precoding process, it can provide flexible beam adaption both for horizontal and vertical domain. Before performing the vertical precoding process, a vertical precoding matrix should be negotiating between a base station and a user equipment by channel measurement and feedback in vertical domain.

CN Patent Publication No. CN102938688A, entitled “Method for channel measurement and feedback for multi-dimensional antenna array”, filed on Aug. 15, 2012, discloses that a base station transmits to UE two classes of channel state information reference signal (CSI-RS) in different subframes corresponding to horizontal domain and vertical domain, receives a horizontal codeword and a vertical codeword from the UE, and obtains obtain a corresponding codeword for data transmission by multiplying the first codeword with the second codeword.

U.S. Patent Publication No. US2013/0258964, entitled “Apparatus and method for channel state information pilot design for an advanced wireless network”, filed on Mar. 14, 2013, discloses that a base station transmits to UE at least two sets of CSI-RS, wherein the 2D antenna array is mapped to one row antenna ports to output the horizontal CSI-RS and is mapped to one column antenna ports to output the vertical CSI-RS, and receives and process a horizontal CSI and a vertical CSI from the UE.

U.S. Patent Publication No. 2013/0259151A1, entitled “Codebook feedback for per user elevation beamforming”, filed on Mar. 29, 2013, discloses that receives reference signals corresponding to both the azimuth and elevation portions of the array of antennas, determines the index of the azimuth codebook portion of a product codebook from the azimuth portion of the received reference signals and determines the index of the elevation codebook portion of the product codebook from the elevation portion of the received reference signals. In antenna configuration, multiple actual vertical antenna elements are mapped into one vertical antenna port.

However, in the solutions disclosed by CN Patent Publication No. CN102938688A and U.S. Patent Publication No. US2013/0258964, one vertical antenna element is equivalent to one vertical antenna port in vertical domain, such that the number of vertical antenna ports is larger than that of horizontal antenna ports, since the number of rows (such as 10, 15) usually is larger than that of columns (such as 2, 3) in the antenna array. Therefore, sometimes it hardly supports the large amount of vertical antenna ports, for example, in some of the current standards, it can only support up to 8 vertical antenna ports. In the method disclosed by U.S. Patent Publication No. 2013/0259151A1, multiple vertical antenna elements are mapped into one vertical antenna ports, which, in one hand, may decrease the number of vertical antenna ports, and on the other hand, may lead to the beamforming gain decreasing compared with the one-one mapping and the coverage reducing in the edge vertical direction.

### SUMMARY OF THE INVENTION

In view of the foregoing problems in the existing approaches, there is a need in the art to provide methods and apparatuses for predicting precoding matrix in a MIMO system.

According to a first aspect of the present invention, embodiments of the invention provide a method for channel measurement and feedback. The method comprises transmitting a first channel state information reference signal (CSI-RS) and a second CSI-RS to a user equipment for vertical CSI measurement, wherein the first CSI-RS is based on antenna configuration of one vertical antenna element mapping to one vertical antenna port, and the second CSI-RS is based on antenna configuration of multiple vertical antenna elements mapping to one vertical antenna port. The method also comprises receiving at least one precoding matrix indicator (PMI), which is fed back by the user equipment in accordance with the first CSI-RS and the second CSI-RS. The method further comprises determining a vertical precoding matrix for data transmission based on the at least one PMI.

According to a second aspect of the present invention, embodiments of the invention provide a method for channel measurement and feedback. The method comprises receiving a first channel state information reference signal (CSI-RS) and a second CSI-RS transmitted by a base station for vertical CSI measurement, wherein the first CSI-RS is based on antenna configuration of one vertical antenna element mapping to one vertical antenna port, and the second CSI-RS is based on antenna configuration of multiple vertical antenna elements mapping to one vertical antenna port. The method also comprises feeding back at least one is precoding matrix indicator (PMI) to the base station in accordance with the first CSI-RS and the second CSI-RS.

According to a third aspect of the present invention, embodiments of the invention provide an apparatus for channel measurement and feedback. The apparatus comprises a transmitting device for transmitting a first channel state information reference signal (CSI-RS) and a second CSI-RS to a user equipment for vertical CSI measurement, wherein the first CSI-RS is based on antenna configuration of one vertical antenna element mapping to one vertical antenna port, and the second CSI-RS is based on antenna configuration of multiple vertical antenna elements mapping to one vertical antenna port. The apparatus also comprises a PMI receiving device for receiving at least one precoding matrix indicator (PMI) which is fed back by the user equipment in accordance with the first CSI-RS and the second CSI-RS. The apparatus further comprises a matrix determining device for determining a vertical precoding matrix for data transmission based on the at least one PMI

According to a fourth aspect of the present invention, embodiments of the invention provide an apparatus for channel measurement and feedback. The apparatus comprises a receiving device for receiving a first channel state information reference signal (CSI-RS) and a second CSI-RS transmitted by a base station for vertical CSI measurement, wherein the first CSI-RS is based on antenna configuration of one vertical antenna element mapping to one vertical antenna port, and the second CSI-RS is based on antenna configuration of multiple vertical antenna elements mapping to one vertical antenna port. The apparatus further comprises a feedback device for feeding back at least one precoding matrix indicator (PMI) to the base station in accordance with the first CSI-RS and the second CSI-RS.

These and other optional embodiments of the present invention can be implemented to realize one or more advantages. In accordance with some embodiments of the present invention, in the instance that the UE measures channel state information in accordance with two CSI-RS's that are based on antenna configuration of one vertical antenna element mapping to one vertical antenna port and multiple vertical antenna elements mapping to one vertical antenna port respectively, and then the base station determines the vertical precoding matrix based on the PMI(s) transmitted by the UE after measuring the channel state information, the method provided in the present invention can be adapted to reduce the overhead of CSI-RS and PMI feedback, meanwhile keep the beamforming gain.

Other features and advantages of the embodiments of the present invention will is also be apparent from the following description of specific embodiments when read in conjunction with the accompanying drawings, which illustrate, by way of example, the principles of embodiments of the invention.

### BRIEF DESCRIPTION OF THE DRAWINGS

Embodiments of the invention are presented in the sense of examples and their advantages are explained in greater detail below, with reference to the accompanying drawings, where:

FIG. 1 illustrates a handshake diagram shown a process of channel measurement and feedback according to an embodiment of the invention;

FIGS. 2A and 2B illustrate the antenna patterns of two DFT codebooks;

FIG. 2C illustrates two precoding matrixes from the codebooks of FIGS. 2A and 2B respectively;

FIG. 3A to 3B illustrate the antenna patterns of three DFT codebooks with different number of mapped vertical antenna ports;

FIG. 4A to 4B illustrate the antenna patterns of three DFT codebooks with different codebook sizes;

FIG. 5A illustrates the possible antenna configuration of the first CSI-RS in a 10×2 antenna array according to an embodiment of the invention;

FIG. 5B illustrates the possible antenna configuration of the second CSI-RS in a 10×2 antenna array according to an embodiment of the invention;

FIG. 6 illustrates the group division for two codebook according to an embodiment of the invention;

FIG. 7 illustrates precoding matrixes from codebook 2 in the FIG. 6 and the codebook for data transmission respectively;

FIG. 8 illustrates the simulation results of UE power consumption comparison according to an embodiment of the invention;

FIG. 9 illustrates the simulation results of overhead reduction comparison according to an embodiment of the invention;

FIG. 10 illustrate a flow chart of a method implemented at the base station according to an embodiment of the invention;

FIG. 11 illustrate a flow chart of a method implemented at the user equipment according to an embodiment of the invention;

FIG. 12 illustrates a block diagram of an apparatus according to an embodiment of the invention; and

FIG. 13 illustrates a block diagram of an apparatus according to an embodiment of the invention.

### DETAILED DESCRIPTION OF EMBODIMENTS

Various embodiments of the present invention are described in detail with reference to the drawings. The flowcharts and block diagrams in the figures illustrate the apparatus, method, as well as architecture, functions and operations executable by a computer program product according to the embodiments of the present invention. In this regard, each block in the flowcharts or block may represent a module, a program, or a part of code, which contains one or more executable instructions for performing specified logic functions. It should be noted that in some alternatives, functions indicated in blocks may occur in an order differing from the order as illustrated in the figures. For example, two blocks illustrated consecutively may be actually performed in parallel substantially or in an inverse order, which depends on related functions. It should also be noted that block diagrams and/or each block in the flowcharts and a combination of thereof may be implemented by a dedicated hardware-based system for performing specified functions/operations or by a combination of dedicated hardware and computer instructions.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in is connection with other embodiments whether or not explicitly described. It shall be understood that the singular forms “a”, “an” and “the” include plural referents unless the context explicitly indicates otherwise.

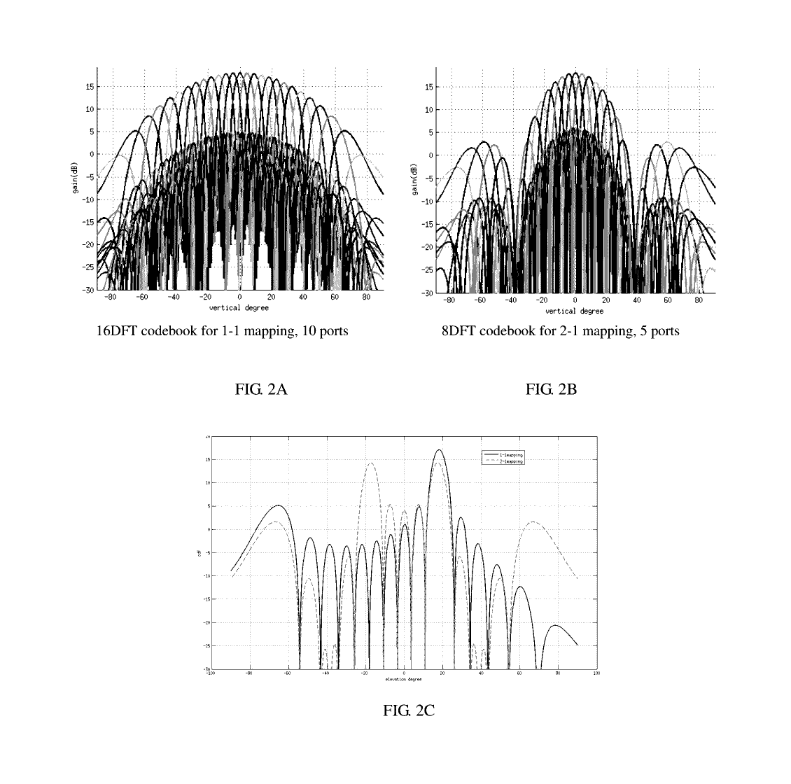

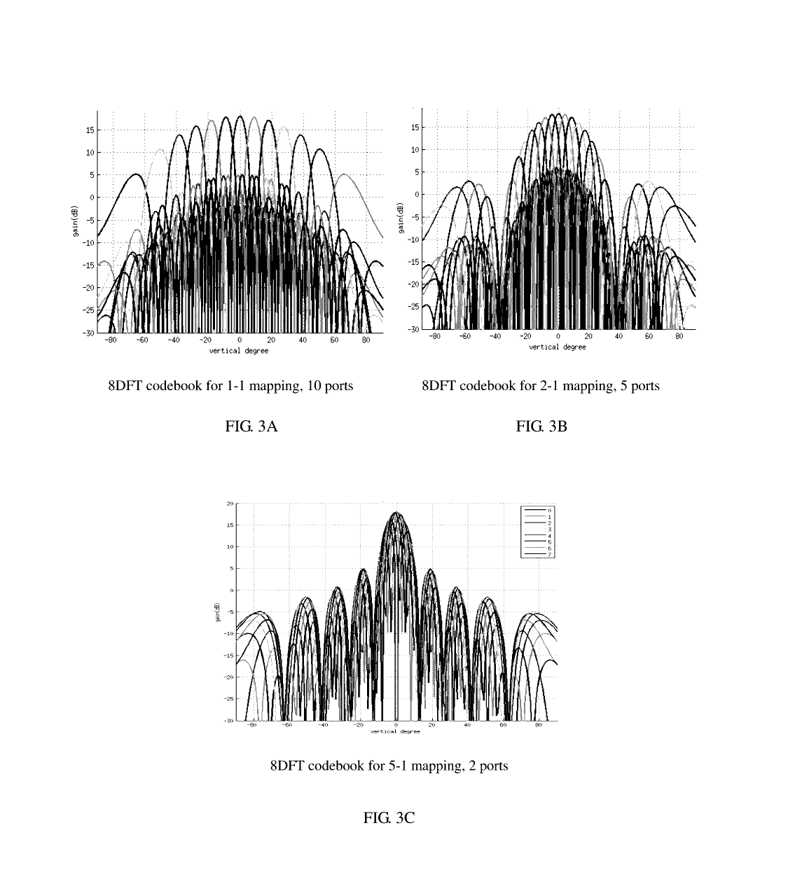

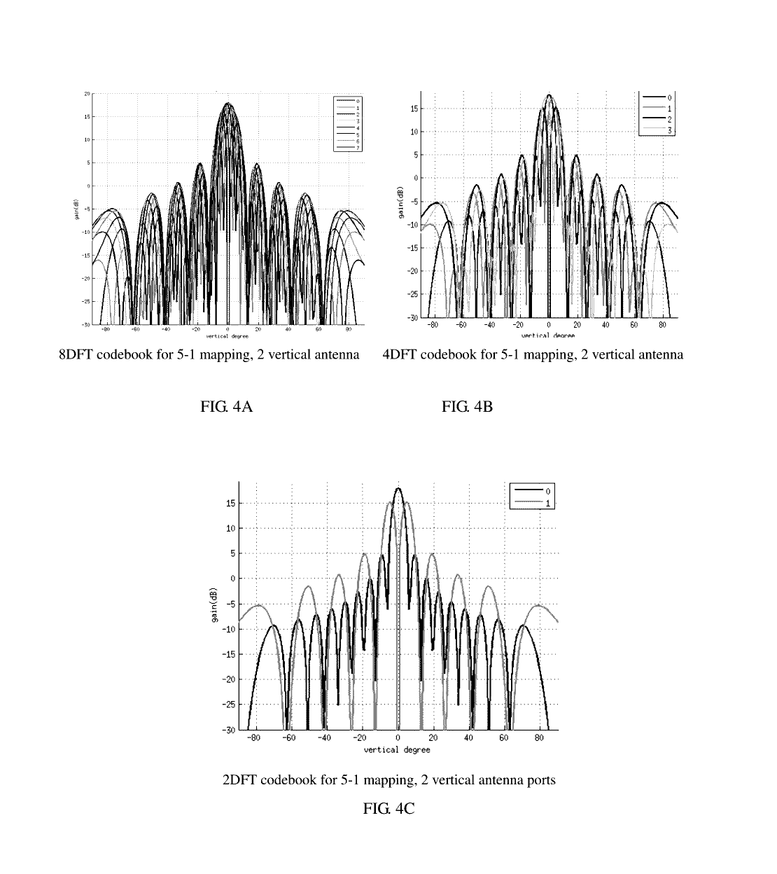

In 3D MIMO system, in order to perform vertical precoding process so as to achieve UE-specific beamforming and spatial multiplexing in vertical domain, a vertical precoding matrix should be determined by vertical channel measurement between a base station and a user equipment. In some of the current solutions, vertical channel measurement and feedback are usually based on array configuration of one vertical antenna element mapping to one vertical antenna port, such as provided in CN Patent Publication No. CN102938688A and U.S. Patent Publication No. US2013/0258964. However, since the number of vertical antenna element is large and all vertical antenna elements should be used in order to measure the channel in vertical direction, it may not be able to support output of the large number of vertical antenna ports. In other solutions, vertical channel measurement and feedback are based on antenna array configuration of multiple vertical antenna elements mapping to one vertical antenna port, for example, 2-1 mapping, such as provided in U.S. Patent Publication No. 2013/0259151A1. In this solution, the number of vertical antenna ports may be decreased, however, two problem will be raise:
(i) The beamforming gain will be decreased compared with the antenna array configuration of one vertical antenna element mapping to one vertical antenna port in one antenna array. FIG. 2A and FIG. 2B respectively show the antenna pattern of a 16DFT codebook for 1-1 mapping and a 8DFT codebook for 2-1 mapping. The antenna array is 10×2 array. In a particular angel, for example, about 20 degree, the beamforming gain of 2-1 mapping in FIG. 2A is lower than of 1-1 mapping in FIG. 2B, as also can be seen from FIG. 2C.
(ii) In antenna configuration of multiple vertical antenna elements mapping to one vertical antenna port in one antenna array, the coverage in the edge vertical direction (−90 and 90 degrees, where 0 degree represents the horizontal plane) is reduced. With the number of vertical antenna elements increasing in one vertical antenna port (the number of total antenna elements in the array remains the same), the precoding matrixes (codewords in a codebook) are more clustered, which in turn may cause deep fading in edge vertical direction area. Therefore, the vertical coverage is smaller. As codebooks illustrated in FIGS. 3A-3C, which are all derived with 8DFT, with the number of antenna elements within one antenna port increasing from FIG. 3A to FIG. 3C, the precoding matrixes are more clustered. Large codebook size may introduce more feedback overhead but still can not introduce much beamforming gain since the near vertical precoding matrixes have similar coverage. As illustrated in FIG. 4A to 4C, with the codebook size increasing from FIG. 4C to FIG. 4A, the beamforming gain may not be increased.

In view of the above, in order to reduce the overhead of feedback, meanwhile maintaining the beamforming gain, embodiments of the present invention provide a method and apparatus for channel measurement and feedback in MIMO system. Reference will be made to the drawings hereinafter so to more fully describe some embodiments of the invention.

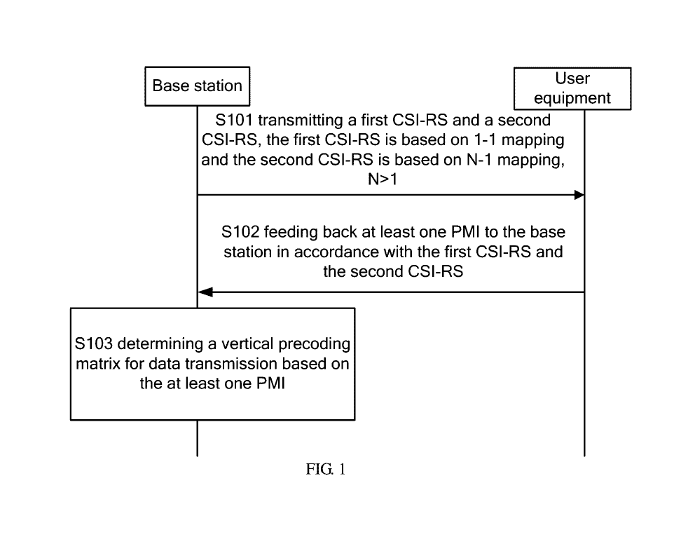

FIG. 1 illustrates a handshake diagram shown a process of channel measurement and feedback according to an embodiment of the present invention.

In step 101, a base station transmits a first channel state information reference signal (CSI-RS) and a second CSI-RS to a user equipment for vertical CSI measurement, wherein the first CSI-RS is based on antenna configuration of one vertical antenna element mapping to one vertical antenna port, i.e. 1-1 mapping, and the second CSI-RS is based on antenna configuration of multiple vertical antenna elements mapping to one vertical antenna port, i.e. N-1 mapping, where N is integer and N>1.

In MIMO system, the base station usually has an antenna array constituted by multiple antenna elements. As used herein, antenna elements refer to the physical antenna elements that actually being contained in the antenna array, and antenna ports refer to the virtualized ports that the antenna elements mapped to, such that signals transmitted from the antenna elements within one antenna port may be regarded as one signal by the user equipment.

The first CSI-RS may be used for the user equipment to roughly estimate the channel state information in vertical direction, and the second CSI-RS may be used for the user equipment to more finely estimate the channel state information in vertical direction. Therefore, according to one embodiment of the invention, in antenna configuration of the first CSI-RS, not all vertical antenna elements have to be mapped as vertical antenna ports, then the overhead of CSI-RS transmission may be reduced. In antenna configuration of the second CSI-RS, all vertical antenna elements should be mapped as vertical antenna ports so as to fully measure the channel in vertical direction. In the second CSI-RS, multiple vertical antenna elements within one vertical antenna port may be weighted by factors. Moreover, in antenna is configurations of both the first and second CSI-RS's, horizontal antenna elements may also be mapped to the vertical antenna ports for transmitting the first and second CSI-RS's according to other embodiments of the invention.

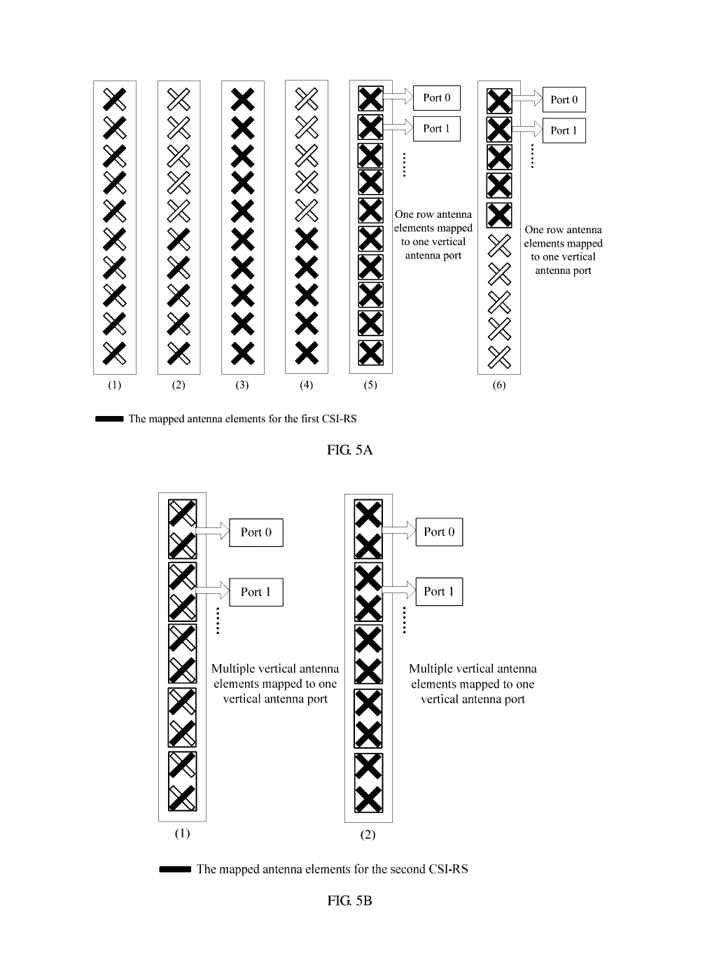

FIG. 5A and FIG. 5B illustrate some possible examples of antenna configuration of the first CSI-RS and the second CSI-RS in a 10×2 antenna array. As shown in FIG. 5A, all vertical antenna elements may be used and mapped as respective antenna ports, such as in (1), (3), and (5), and in antenna configuration of (2), (4), and (6), not all vertical antenna elements are used. Moreover, in antenna configuration of (5) and (6), besides one vertical antenna element, one additional horizontal antenna element is also mapped to one vertical antenna port. As shown in FIG. 5B, all vertical antenna elements are used and multiple ones are mapped to one vertical antenna ports in both (1) and (2). Also, in antenna configuration of (2), horizontal antenna element(s) can be mapped to one vertical antenna element. It should be noted that antenna configurations for the first and second CSI-RS's are not limited by the illustrated examples and can be configured in numerous manner.

Except antenna configuration, the transmission period may also be set. According to one embodiment of the invention, the base station may transmit the first CSI-RS to the user equipment in a first period; and transmit the second CSI-RS to the user equipment in a second period, wherein the first period is larger than the second period since the first CSI-RS is used to roughly estimate the channel state information. For example, if the second period may be set as 10 ms, the first period may be multiple of the second period. Other time durations can also be applied.

The process then proceeds to step 102, the user equipment feeds back at least one precoding matrix indicator (PMI) to the base station in accordance with the first CSI-RS and the second CSI-RS.

In some embodiments of the invention, the user equipment may receive the first CSI-RS and the second CSI-RS, and then measure the channel state information according to the first CSI-RS and the second CSI-RS. The known approaches of CSI-RS measurement in the art can be used. The user equipment may determine the PMI from a codebook based on the measurement results.

As known in the art, a codebook may contain multiple precoding matrixes, also referred to precoding vectors or codewords, which may be interchangeably used herein. The number of precoding matrixes represents the size of the codebook, and the precoding matrixes is are usually defined by the size of the codebook and the number of vertical antenna ports that transmit the CSI-RS. Each precoding matrix may correspond to a PMI, and the precoding matrix may be identified by PMI. For example, if there are 16 precoding matrixes in a codebook, it may need at least 4 bits for the PMI to indicate each precoding matrix. There are various ways to derive a codebook, and in the invention, a DFT codebook is used by way of example.

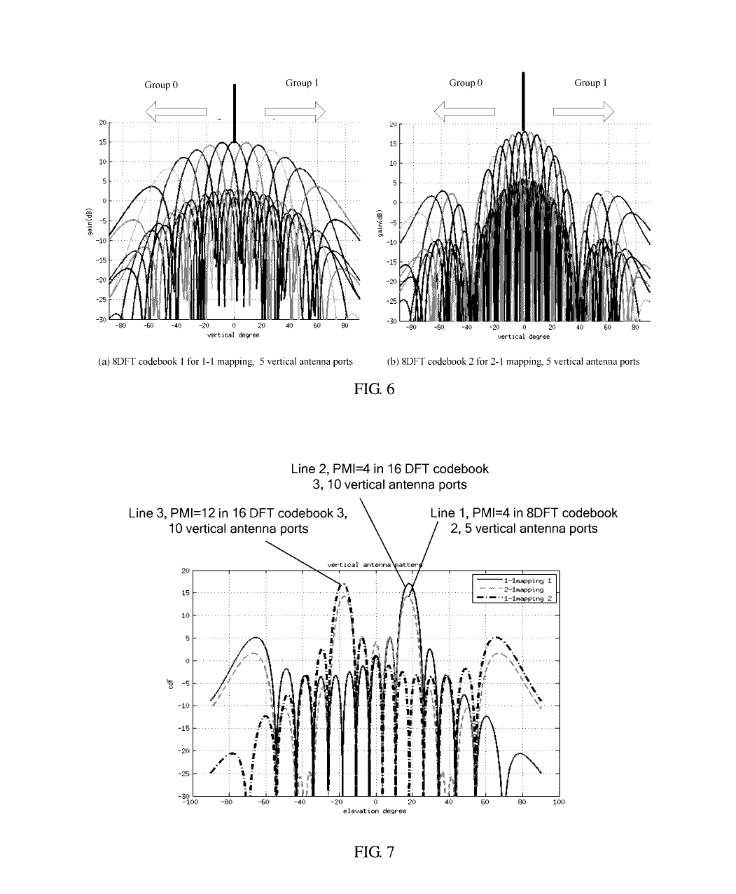

In embodiments of the invention, a first codebook for the first CSI-RS and a second codebook for the second CSI-RS are predefined in both the base station and the user equipment. In the example of DFT codebook, the first codebook with 8DFT based on 5 vertical antenna ports (1-1 mapping, such as (1), FIG. 5A) may be presented in formula (1) and the vertical antenna pattern of the first codebook is shown in (a), FIG. 6.

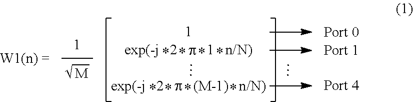

The second codebook with 8DFT based on 5 vertical antenna ports (2-1 mapping, such as (1) or (2), FIG. 5B) may be presented in formula (2) from the base station side, and may be presented in formula (3) from the user equipment side. The vertical antenna pattern of the second codebook is shown in (b), FIG. 6.

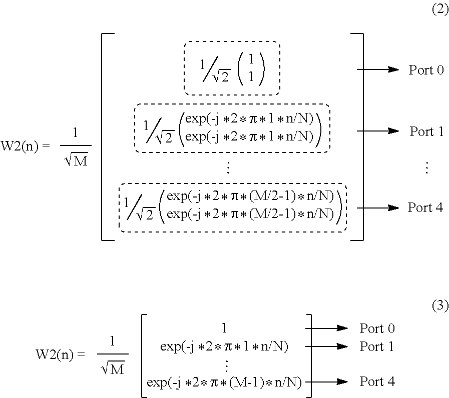

Where M is the number of vertical antenna ports, and N is the size of the codebook, which is equal to the DFT size in DFT codebook, W1(n) is the n^{th} codeword, i.e. the n^{th} precoding matrix, in the first codebook, and W2(n) is the n^{th} precoding matrix in the second codebook. In this case, in both the first and second codebooks, M=5 and N=8. If the N and M are the same in both the first and second codebooks, from the user equipment side, the two codebooks are usually the same since the user equipment may only measure the channel per vertical antenna port.

Since antenna configurations of the first and second CSI-RS's set by the base station are different, the user equipment may not be able to distinguish which one of received CSI-RS's is the first CSI-RS or the second CSI-RS if without configuration information from the base station. Depending on whether the difference between the first CSI-RS and the second CSI-RS is known to the user equipment, the embodiments of the invention provide several approaches for the user equipment to feed back the PMI to the base station in accordance with the first CSI-RS and the second CSI-RS, as set forth below:

(I) The user equipment may determine a first PMI in a first codebook in accordance with the first CSI-RS; determine a second PMI in a second codebook in accordance with the second CSI-RS; and feed back the first PMI and the second PMI to the base station.

In the approach (I), the known methods of determining PMIs according to the CSI-RS's can be used. The user equipment may or may not know the difference between the first CSI-RS and the second CSI-RS in this approach.

In one embodiment of the invention, when the difference between the first CSI-RS and the second CSI-RS is unknown to the user equipment, and the first codebook is the same to the second codebook, the user equipment may feed back the first PMI to the base station in a period equal to the transmission period of the first CSI-RS; and feed back the second PMI to the base station in a period equal to the transmission period of the second CSI-RS. In this embodiment, the first codebook is the same to the second codebook, such that the user equipment may always determine the PMI for each received CSI-RS in the same codebook.

In this embodiment, if the user equipment can not known the difference, it may not need to distinguish the first and second CSI-RS's and may feed back each PMI in the period equal to respective transmission period, i.e. the period of PMI reception. As such the base is station may distinguish the two PMIs by determining whether their feedback periods are equal to their transmission period. The base station may determine a precoding matrix in accordance with the first PMI and the second PMI, which may be described latter.

It should be noted that at some time point the first and second CSI-RS's may both be transmitted because of their transmission period. For example, if the transmission period of the first CSI-RS is 50 ms and that of the second CSI-RS is 20 ms, than the first and second CSI-RS's may both be transmitted at the time point of 100 ms. However, regarding the different antenna configuration of CSI-RS's, only one of them can be transmitted at one time. Therefore, in this case, the base station may decide that one of the first and second CSI-RS's is transmitted. Then, one PMI may be determined based on the current transmitted CSI-RS, and the previously determined PMI of the other CSI-RS may be used.

If the difference between the first CSI-RS and the second CSI-RS is known to the user equipment, it may directly determine the two PMIs and know which PMI is corresponding to the first or the second CSI-RS. The first codebook and the second codebook may or may not be the same.

(II) When the difference between the first CSI-RS and the second CSI-RS is known to the user equipment, the user equipment may determine a first PMI in a first codebook in accordance with the first CSI-RS; determine an group index corresponding to the first PMI in the first codebook; determine a second PMI in a group of a second codebook corresponding to the determined group index in accordance with the second CSI-RS; and feed back the second PMI and feeding back the group index corresponding to the first PMI to the base station, wherein the first codebook and the second codebook are divided into a plurality of groups in the same manner.

In the approach (II), the user equipment can distinguish the first CSI-RS and the second CSI-RS. According to one embodiment of the invention, the user equipment may distinguish the first and second CSI-RS's based on configuration information of at least one of the first CSI-RS or the second CSI-RS. The exemplary ways of distinguishing the first and second CSI-RS's may be described later.

In this approach, the first codebook and the second codebook may be divided into multiple groups, and the number of groups in each codebook is the same. In some examples, the first and second codebook may be or may not be the same, and the codebook size or the is number of mapped vertical antenna ports used to transmit CSI-RS may be or may not be the same.

The user equipment may provide the second PMI and the group index corresponding to the first PMI, since the group index usually needs fewer bits to transmit compared with the first PMI. As such, the PMI feedback may be reduced compared with that in the approach (I).

Moreover, since the second codebook may also be divided in the same manner to the first codebook, then the second PMI may be selected in the group of the second codebook corresponding to the determined group index. Since the precoding matrixes in a group may be less than that in the whole codebook, fewer bits may be used to identify the precoding matrix that is determined based on the CSI-RS. As such, the PMI feedback may be further reduced.

For example, for the first codebook with 5 vertical ports (1-1 mapping) based on 8DFT and the second codebook with 5 vertical antenna ports (2-1 mapping) based on 8DFT, as illustrated in FIG. 6, them may both be divided into two groups, Group 0 and Group 1, in the same manner. Then 1 bit is needed to identify the group index. If the first PMI is determined to be in Group 1 of the first codebook, the value 1 of the bit may be used to indicate the group index 1. Further, a second PMI may be determined in Group 1 of the second codebook. The second codebook totally contains 8 precoding matrixes, and 3 bits may be needed to identify each precoding matrix in the second codebook without group division. Now since the second codebook is divided into two groups, for each group, 4 precoding matrixes are contained, then only 2 bits is needed for the second PMI to identify the precoding matrixes. Therefore, a 2-bit second PMI can be determined from Group 1 of the second codebook.

According to other embodiment of the invention, the user equipment may directly determine the second PMI in the second codebook without the determined group index according to the second CSI-RS.

After determining the group index corresponding to the first PMI and the second PMI, the user equipment may feed back the second PMI and feeding back the group index corresponding to the first PMI to the base station. Then the base station may determine a precoding matrix in accordance with the group index corresponding to the first PMI and the second PMI, which may be described latter.

(III) When the difference between the first CSI-RS and the second CSI-RS is is known to the user equipment, the user equipment may determine a first PMI in a first codebook in accordance with the first CSI-RS; determine a second PMI in a second codebook in accordance with the second CSI-RS; determine a third PMI based on at least one of the first PMI and the second PMI; and feed back the third PMI to the base station.

In the approach (III), the user equipment may distinguish the first CSI-RS and the second CSI-RS. The specific ways of distinguishing the first and second CSI-RS's may be described later.

In this approach, the known ways of determining PMI according to the CSI-RS can be used. The user equipment may only feed back to the base station the third PMI, which is determined in accordance with at least one of the first PMI and the second PMI. The third PMI may be used to indicate the final vertical precoding metric for data transmission for the base station. As such, the overhead of PMI feedback is reduced compared with the approach (I) or (II).

According to one embodiment of the invention, the user equipment may determine an group index corresponding to the first PMI in the first codebook; determine, in a group of the second codebook corresponding to the determined group index, an angel with the maximum gain in a precoding matrix indicated by the second PMI; and determine the third PMI in a codebook for data transmission based on the determined angel, wherein the first codebook and the second codebook are divided into a plurality of groups in the same manner.

In this embodiment, two codebooks are divided into a plurality groups in the same manner and the number of groups in each codebook are the same. Also as in approach (II), the first and second codebook may be or may not be the same, and the codebook size or the number of mapped vertical antenna ports used to transmit CSI-RS may be or may not be the same.

For example, for the first codebook with 5 vertical ports (1-1 mapping) based on 8DFT and the second codebook with 5 vertical antenna ports (2-1 mapping) based on 8DFT, as illustrated in FIG. 6, they may both be divided into two groups, Group 0 and Group 1, in the same manner. Since the precoding matrix indicated by the second PMI may have two peak value of gain in two vertical angels, such as shown by the Line 1 in FIG. 7, when determining the first PMI is in Group 1 of the codebook 1, the user equipment may determine one particular angel with the maximum gain in Group 1 of the codebook 2, i.e., from 0 to 90 degrees. This particular angel is the vertical angel that the user equipment prefers to be used for data is transmission after the channel measurement. Then, in a codebook for data transmission, which may be a third codebook, the user equipment may determine the third PMI indicating a precoding matrix in the determined angel. It should be noted that the codebook for data transmission is usually based on 1-1 mapping in MIMO system, that is, one vertical antenna element may be used as one vertical antenna port, such as a codebook with 10 vertical antenna ports based on 16 DFT in the 10×2 antenna array.

According to another embodiment of the invention, the user equipment may determine, in a codebook for data transmission, a PMI corresponding to a precoding matrix with a maximum difference between maximum gains compared to a precoding matrix indicated by the second PMI as the third PMI.

In this embodiment of the invention, only the second PMI is used to determine the third PMI as the precoding matrix indicated by the second PMI may be better than the precoding matrix indicated by the first PMI, since the channel may be more accurately estimated based on the configuration set for the second CSI-RS, including antenna configuration and transmission period. The determination of the third PMI may be represented as formula (4):

Codeword_index=arg max{MaxBeamGain(codeword_index,θ)−MaxBeamGain(PMI2_index,θ)} (4)

where codeword_index is the index of precoding matrix in the codebook for data transmission, and by having each precoding matrix contained in the codebook for data transmission calculation, the one precoding matrix with a maximum difference between maximum gains compared to a precoding matrix indicated by the second PMI may be determined, and the PMI of the determined precoding matrix may be determined as the third PMI.

In above approaches, the size of the first codebook may be smaller than the size of the second codebook since the first CSI-RS is usually used to roughly estimate the channel. Then the feedback PMI corresponding to the first PMI may be reduced because of the small codebook size, since few bits may be needed to identify the first PMI. Moreover, the first PMI may be determined on a wideband by the user equipment, and then the whole channel in the frequency domain may be roughly estimated. The second PMI may be determined on a wideband or a subband by the user equipment. According to the first PMI and the second PMI, a vertical precoding matrix may be determined particularly for the subband. Otherwise, the second PMI may be also determined on a wideband, and then a vertical precoding matrix may is be determined for the wideband. Since the transmission period of the first CSI-RS may be long, and that of the second CSI-RS may be smaller, the first PMI may indicate a long term precoding matrix and the second PMI may indicate a short term precoding matrix for the channel measurement.

In some of the above approaches, the user equipment may need to differentiate the first CSI-RS and the second CSI-RS. In order to facilitate the user equipment to acknowledge the difference between the first CSI-RS and the second CSI-RS, in one example, the base station may inform the user equipment configuration information of at least one of the first CSI-RS and the second CSI-RS. The configuration information may include one or more of: transmission period, subframe offset, the number of mapped vertical antenna ports, and position information of resource.

In one example, the base station may explicitly inform the configuration information of both CSI-RS's, for example, by Radio Resource Control (RRC) signal. Then the user equipment may differentiate which one of the received CSI-RS is the first or the second CSI-RS by their configuration information.

In another example, the base station may inform the user equipment that there are two types of CSI-RS and inform implicitly the difference between configuration information of the first CSI-RS and the second CSI-RS, such as the first CSI-RS is based on larger number of vertical antenna ports, or is transmitted in a longer period. Then the user equipment may explicitly know there are two types of CSI-RS, and may differentiate which one is the first or the second CSI-RS based on the difference between configuration information of the two CSI-RS's, for example, the one transmitted by larger number of vertical antenna ports or in a longer period is the first CSI-RS, and the other one is the second CSI-RS.

In yet another example, the configuration information of both CSI-RS's may be the same except the transmission periods. Then the base station may inform the user equipment one configuration information and transmitting the first CSI-RS and the second CSI-RS in different subframes. The configuration information may be used by the user equipment to receive both of the first and second CSI-RS's. Since the transmission periods are different, the user equipment may then distinguish the first CSI-RS or the second CSI-RS by their different transmission period.

The process then proceeds to step 103, the base station determine a vertical precoding matrix for data transmission based on the at least one PMI.

After the user equipment feeds back the at least one PMI, for example, the first and second PMIs, or the second PMI and the group index corresponding to the first PMI, or the third PMI, the base station may receive the PMI(s) and then determine a vertical precoding matrix for data transmission based on the PMI(s). Depending on what kind of PMI(s) is received as well as depending on whether or not the user equipment knows the difference between the first CSI-RS and the second CSI-RS, several approaches for determining the vertical precoding matrix for data transmission are provided according to some embodiment of the invention.

(A): When two PMIs are received, and one of which is a first PMI corresponding to the first CSI-RS and the other is a second PMI corresponding to the second PMI, the base station may determine the vertical precoding matrix for data transmission based on at least one of the first PMI and the second PMI.

In the approach (A), the user equipment may or may not know the difference between the first CSI-RS and the second CSI-RS. In the case that the user equipment does not know the difference, as mentioned in the above approach (I), the user equipment may feed back the first PMI and the second PMI in the periods that are equal to the transmission periods of the first and second CSI-RS. Since the transmission period of the first CSI-RS is larger than that of the second CSI-RS, the base station may determine the PMI received in a period equal to the transmission period of the first CSI-RS as the first PMI, and determine the PMI received in a period equal to the transmission period of the second CSI-RS as the second PMI.

When the first PMI corresponding to the first CSI-RS and the second PMI corresponding to the second CSI-RS are determined, the base station determining the vertical precoding matrix for data transmission based on at least one of the first PMI and the second PMI.

In one embodiment, the base station may determine, in a codebook for data transmission, a precoding matrix with a maximum difference between maximum gains compared to a precoding matrix indicated by the second PMI as the vertical precoding matrix. For example, the vertical precoding matrix with the maximum difference may be determined by the formula (4), as described in the above approach (III), which may be omitted here for the sake of simplicity.

In another embodiment, the base station may determine the vertical precoding is matrix for data transmission by multiplying a precoding matrix indicated by the first PMI and a precoding matrix indicated by the second PMI.

In this embodiment, no additional codebook for data transmission is needed. The vertical precoding matrix may be directly obtained by the product of the two precoding matrixes indicated by the first and second PMIs. Since the first PMI is corresponding to the first CSI-RS which has antenna configuration of one vertical antenna element mapping to one vertical antenna port, values within the precoding matrix indicated by the first PMI may represent intra-port weighting factors, that is, weighting factors of vertical antenna elements. The values within the precoding matrix indicated by the second PMI may represent inter-port weighting factors. By taking account of both the intra-port and inter-port weightings, the vertical precoding matrix may be more accurate for data transmission to the user equipment.

In order to achieve the multiplication of two precoding matrixes, the number of mapped vertical antenna ports corresponding to the first PMI should be equal to the number of mapped vertical antenna ports corresponding to the second PMI. As can be see from the formulas (1)-(3), if the number of mapped vertical antenna ports are equal, the precoding matrix W1 of the first PMI can be multiplied to the precoding W2 of the second PMI. The first codebook and the second codebook may not be necessarily the same, since the codebook size may be different.

(B): When the received PMI is the second PMI and the difference between the first CSI-RS and the second CSI-RS is known to the user equipment, the base station may also receive the an group index of the first PMI in the first codebook fed back by the user equipment. As such, the PMI feedback may be reduced, as mentioned in the above approach (II). In this case, the base station may perform the following (i) and (ii) to determine a vertical precoding matrix for data transmission based on the at least one PMI.

(i) The base station may determine, in a group of a second codebook corresponding to the received group index, an angle with the maximum gain in a precoding matrix indicated by the second PMI; and determining the vertical precoding matrix in a codebook for data transmission based on the determined angle.

In the user equipment side, as noted above, the first codebook and the second codebook are divided into a plurality of groups in the same manner. In the base station side, the base station may also acknowledge how the two codebooks are divided.

Usually, since the second CSI-RS is based on N-1 mapping, the precoding matrix indicated by the second PMI may have more than one peak gain value, it is hard for the base station to select one angel corresponding to the peak gain value. With the group index, the angel that preferred by the user equipment may be selected.

For example, if the precoding matrix indicated by the second PMI is illustrated as Line 1 in FIG. 7, since there are two angels that both corresponding to the maximum gain, and there may be two precoding matrixes, Lines 2 and 3, in the codebook for data transmission. Then the base station may not know which one to be selected. If the two codebooks are divided as illustrated in FIG. 6, and if the received group index indicates Group 1 in the codebook 1, the base station may determine the angle with the maximum gain in Group 1 of the codebook 2.

Since the codebook for data transmission is based on 1-1 mapping in the MIMO system, in a particular angel, the beamforming gain in the codebook for data transmission is higher than that in the second codebook, which is based on N-1 mapping. Therefore, the base station may usually choose the precoding matrix in the particular angel from the codebook for data transmission. For example, in FIG. 7, when the base station determining the angel with the maximum gain is in Group 1 of codebook 2, i.e., from 0 to 90 degree, as illustrated in Line 1, the angel may be approximate 18 degree. And the precoding matrix in 18 degree in the codebook for data transmission is Line 2, the maximum beamforming gain of Line 2 in 18 degree is higher than that of Line 1.

With the angel that is preferred by the user equipment, the base station may determine the precoding matrix in the determined angel in the codebook for data transmission.

(ii) The base station may determine a precoding matrix with maximum gain in a group of a first codebook corresponding to the received group index; and determining the vertical precoding matrix for data transmission by multiplying the determined precoding matrix and a precoding matrix indicated by the second PMI.

In the case that the base station receives an group index instead of the first PMI, it may determine from the group of the first codebook a precoding matrix with maximum beamforming gain, values within which may also represent intra-port weighting factors. By multiplying the precoding matrix indicated by the second PMI, the product may be obtained as the vertical precoding matrix for data transmission.

Also, the number of mapped vertical antenna ports corresponding to the first PMI is equal to the number of mapped vertical antenna ports corresponding to the second PMI.

(C): when the received PMI is one PMI determined by the user equipment for data transmission and the difference between the first CSI-RS and the second CSI-RS is known to the user equipment, determining a vertical precoding matrix for data transmission based on the at least one PMI including: determining a precoding matrix indicated by the received PMI in a codebook for data transmission as the vertical precoding matrix.

The approach (C) is corresponding to the above approach (III), the user equipment has determined and fed back a third PMI that may be indicate the vertical precoding matrix for data transmission. Therefore, the base station may not further calculate the vertical precoding and may use the precoding matrix indicated by the received PMI in the codebook for data transmission.

As discussed above, by the approaches (A)-(C), the base station may determine the vertical precoding matrix for data transmission in the MIMO system. It should be noted that the process of the invention may be performed in accordance with any other suitable communication standard or specification that uses MIMO signals, such as, for example, Wideband Code Division Multiple Access (WCDMA), WiMAX or WiFi.

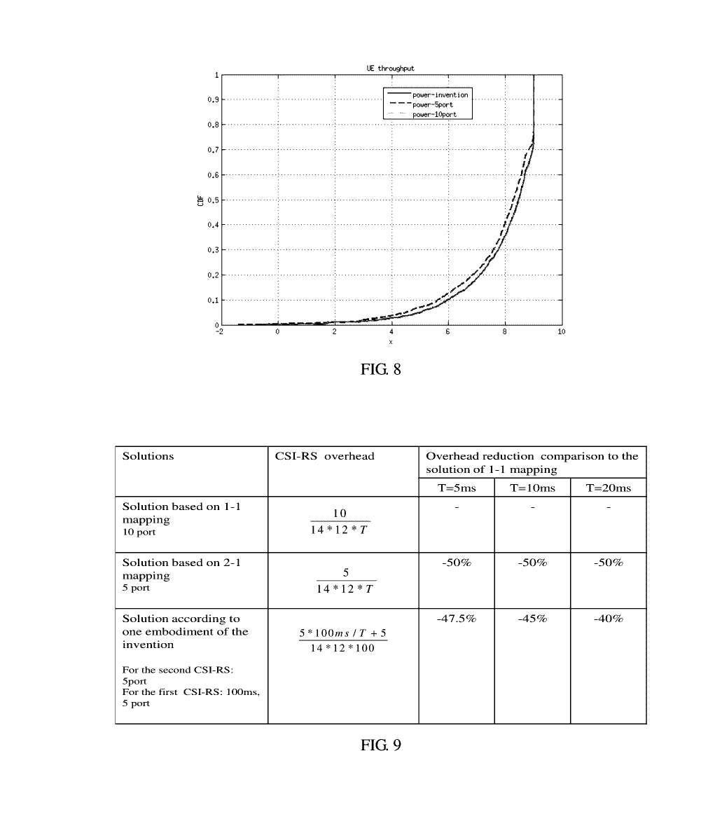

FIG. 8 and FIG. 9 illustrate the simulation result comparison of the solution according to one embodiment of the invention and two other solutions, one of which is based on total 1-1 mapping, and the other one of which is based on total 2-1 mapping. The antenna array is 10×2 in the three solutions.

As can be seen from FIG. 8, the power consumption of UE in the invention is approximately equal to that of two other solutions. And as shown in FIG. 9, although the overhead reduction of the invention is not as large as that of the solution based on 2-1 mapping, the overhead is also reduced compared with the solution based on 1-1 mapping.

Moreover, since the first and second CSI-RS's are transmitted periodically, the process as illustrated in the FIG. 1 may be periodically perform so as to update the vertical precoding matrix. Since the transmission period of the second CSI-RS is smaller than that of the first CSI-RS, the second PMI may be updated more frequently, therefore, in some embodiments of the invention; the base station may determine the vertical precoding matrix in accordance with the updated second PMI and the previous first PMI or group index. Also, the is user equipment may determine the third PMI based on the updated second PMI and the previous first PMI or group index, and then feed back the updated third PMI to the base station.

Further, the base station may modify antenna configuration of the second CSI-RS based on the long term observation of the first PMI. In one embodiment, determining the variation between multiple received group indexes of group or between multiple received first PMI; when the range of variation is lower than a predetermined threshold, increasing the number of vertical antenna elements mapped to one vertical antenna ports when transmitting the second CSI-RS; when the range of variation is higher than the predetermined threshold, decreasing the number of vertical antenna elements mapped to one vertical antenna ports when transmitting the second CSI-RS; changing the second codebook in accordance with the number of mapped vertical antenna ports; and informing the user equipment the changed second codebook.

In one example, if the group index remains in the same, or varies in a small range, it may be determined that the range of variation is low. Also, if the first PMI remains in the same group or various in a few groups, the range of variation is determined as low. Otherwise, the range of variation is determined as high.

In some embodiments, if the range of variation is low, it means that the angels the user equipment preferred varies in a small range. Then, the number of vertical antenna elements mapping to one vertical antenna port may be increased, and the number of mapped vertical antenna ports may be decreased since the total vertical antenna elements in the antenna array remains the same. With the vertical antenna ports decreasing, the precoding matrixes are more clustered if the same codebook size is used. As can be seen in FIGS. 3B-3C, the precoding matrixes in the codebook of FIG. 3C with the 8DFT based on 5-1 mapping is more clustered than that in FIG. 3B, which is with the 8DFT based on 2-1 mapping. If the number of mapped vertical antenna port is changed, the second codebook may also be reset.

Moreover, since large codebook size may introduce more feedback overhead but still can not introduce much beamforming gain since the near vertical precoding matrixes have similar coverage, as illustrated in FIG. 4A to 4C. The size of the second codebook may be decrease the size of the second codebook according to the decreased number of vertical antenna ports and modified the precoding matrixes in the second codebooks according to the decreased number of mapped vertical antenna ports, as well as the size of the second codebook. Since the is size is decreased, the PMI used to indicate the precoding matrixes may need fewer bits, and then the PMI feedback is decreased.

In some embodiment, if the range of variation is high, in order to cover the user equipment that often chooses the edge PMI, the number of vertical antenna elements within one vertical antenna port may be decreased.

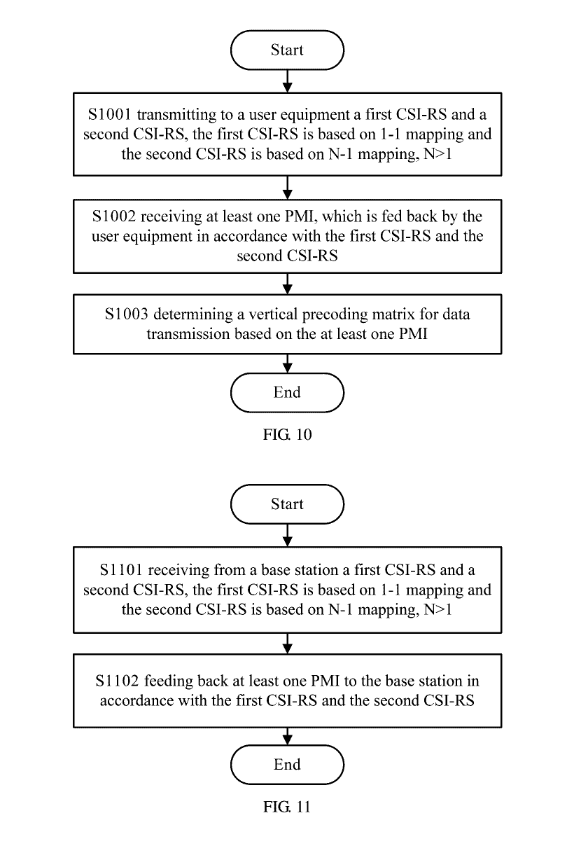

FIG. 10 and FIG. 11 illustrate the methods performed in the base station side and the user equipment side respectively during the process illustrated in FIG. 1, as described in the above and as briefly presented in the following.

With reference to FIG. 10, at step 1001, the base station transmits to a user equipment a first CSI-RS and a second CSI-RS, the first CSI-RS is based on 1-1 mapping and the second CSI-RS is based on N-1 mapping, N>1.

According to an embodiment, transmitting a first CSI-RS and a second CSI-RS to a user equipment including: transmitting the first CSI-RS to the user equipment in a first period; and transmitting the second CSI-RS to the user equipment in a second period, wherein the first period is larger than the second period.

At step 1002, the base station receives at least one PMI, which is fed back by the user equipment in accordance with the first CSI-RS and the second CSI-RS.

According to an embodiment, wherein when the received PMI is a second PMI corresponding to the second CSI-RS and the difference between the first CSI-RS and the second CSI-RS is known to the user equipment, the method further comprises: receiving an group index of a first PMI in a first codebook fed back by the user equipment and corresponding to the first CSI-RS, wherein a first codebook corresponding to the first CSI-RS and a second codebook corresponding to the second CSI-RS are divided into a plurality of groups in the same manner.

According to an embodiment, wherein determining a vertical precoding matrix for data transmission based on the at least one PMI including: determining, in a group of the second codebook corresponding to the received group index, an angle with the maximum gain in a precoding matrix indicated by the second PMI; and determining the vertical precoding matrix in a codebook for data transmission based on the determined angle.

According to another embodiment, wherein determining a vertical precoding matrix for data transmission based on the at least one PMI including: determining, in a group of the first codebook corresponding to the received group index, a precoding matrix with is maximum gain; and determining the vertical precoding matrix for data transmission by multiplying the determined precoding matrix and a precoding matrix indicated by the second PMI, wherein the number of mapped vertical antenna ports corresponding to the first PMI is equal to the number of mapped vertical antenna ports corresponding to the second PMI.

According to yet another embodiment, wherein when two PMIs are received, and one of which is a first PMI corresponding to the first CSI-RS and the other is a second PMI corresponding to the second PMI, determining a vertical precoding matrix for data transmission based on the at least one PMI including: determining the vertical precoding matrix for data transmission based on at least one of the first PMI and the second PMI.

According to an embodiment, wherein determining the vertical precoding matrix for data transmission based on at least one of the first PMI and the second PMI including: determining, in a codebook for data transmission, a precoding matrix with a maximum difference between maximum gains compared to a precoding matrix indicated by the second PMI as the vertical precoding matrix.

According to an embodiment, wherein determining the vertical precoding matrix for data transmission based on at least one of the first PMI and the second PMI including: determining the vertical precoding matrix for data transmission by multiplying a precoding matrix indicated by the first PMI and a precoding matrix indicated by the second PMI, wherein the number of mapped vertical antenna ports corresponding to the first PMI is equal to the number of mapped vertical antenna ports corresponding to the second PMI.

According to an embodiment, wherein when the difference between the first CSI-RS and the second CSI-RS is unknown to the user equipment, the method further comprising: determining the PMI received in a period equal to the transmission period of the first CSI-RS as the first PMI; and determining the PMI received in a period equal to the transmission period of the second CSI-RS as the second PMI.

According to an embodiment, in order to facilitate the user equipment to acknowledge the difference between the first CSI-RS and the second CSI-RS, the method further comprising: informing the user equipment configuration information of at least one of the first CSI-RS and the second CSI-RS, wherein the configuration information including one or more of: transmission period, subframe offset, the number of mapped vertical antenna ports, and position information of resource.

According to an embodiment, the method further comprises: determining the variation between multiple received group indexes of group or between multiple received first PMI; when the range of variation is lower than a predetermined threshold, increasing the number of vertical antenna elements mapped to one vertical antenna ports when transmitting the second CSI-RS; when the range of variation is higher than the predetermined threshold, decreasing the number of vertical antenna elements mapped to one vertical antenna ports when transmitting the second CSI-RS; changing the second codebook in accordance with the number of mapped vertical antenna ports; and informing the user equipment the changed second codebook.

According to an example, wherein when the number of vertical antenna elements mapped to one vertical antenna ports is increased, the number of mapped vertical antenna ports is decreased, changing the second codebook in accordance with the number of mapped vertical antenna ports including: decreasing the size of the second codebook and modifying precoding matrixes in the second codebook, in accordance with the decreased number of mapped vertical antenna ports.

According to an embodiment, wherein the size of the first codebook is smaller than the size of the second codebook. 15. According to another embodiment, wherein the first PMI is determined on a wideband by the user equipment, and the second PMI is determined on a wideband or a subband by the user equipment.

At step 1003, the base station determining a vertical precoding matrix for data transmission based on the at least one PMI.

With reference to FIG. 11, at step 1101, the user equipment receives from a base station a first CSI-RS and a second CSI-RS, the first CSI-RS is based on 1-1 mapping and the second CSI-RS is based on N-1 mapping, N>1.

According to an embodiment, receiving a first CSI-RS and a second CSI-RS transmitted by a base station including: receiving the first CSI-RS transmitted by the base station in a first period; and receiving the second CSI-RS transmitted by the base station in a second period, wherein the first period is larger than the second period

At step 1102, the user equipment feeds back at least one PMI to the base station in accordance with the first CSI-RS and the second CSI-RS.

According to an embodiment, when the difference between the first CSI-RS and is the second CSI-RS is known to the user equipment, feeding back at least one PMI to the base station in accordance with the first CSI-RS and the second CSI-RS including: determining a first PMI in a first codebook in accordance with the first CSI-RS; determining a second PMI in a second codebook in accordance with the second CSI-RS; determining a third PMI based on at least one of the first PMI and the second PMI; and feeding back the third PMI to the base station.

According to an example embodiment, wherein determining a third PMI based on at least one of the first PMI and the second PMI including: determining an group index corresponding to the first PMI in the first codebook; determining, in a group of the second codebook corresponding to the determined group index, an angel with the maximum gain in a precoding matrix indicated by the second PMI; and determining the third PMI in a codebook for data transmission based on the determined angel, wherein the first codebook and the second codebook are divided into a plurality of groups in the same manner.

According to an example embodiment, wherein determining a third PMI based on at least one of the first PMI and the second PMI including: determining, in a codebook for data transmission, a PMI corresponding to a precoding matrix with a maximum difference between maximum gains compared to a precoding matrix indicated by the second PMI as the third PMI.

According to another embodiment, wherein when the difference between the first CSI-RS and the second CSI-RS is known to the user equipment, feeding back at least one PMI to the base station in accordance with the first CSI-RS and the second CSI-RS including: determining a first PMI in a first codebook in accordance with the first CSI-RS; determining an group index corresponding to the first PMI in the first codebook; determining, in a group of a second codebook corresponding to the determined group index, a second PMI in accordance with the second CSI-RS; and feeding back the second PMI and the group index corresponding to the first PMI to the base station, wherein the first codebook and the second codebook are divided into a plurality of groups in the same manner.

According to yet another embodiment, wherein feeding back at least one PMI to the base station in accordance with the first CSI-RS and the second CSI-RS including: determining a first PMI in a first codebook in accordance with the first CSI-RS; determining a second PMI in a second codebook in accordance with the second CSI-RS; and feeding back the first PMI and the second PMI to the base station.

According to an example embodiment, wherein when the difference between the first CSI-RS and the second CSI-RS is unknown to the user equipment, and the first codebook is the same to the second codebook, feeding back the first PMI and the second PMI to the base station including: feeding back the first PMI to the base station in a period equal to the transmission period of the first CSI-RS; and feeding back the second PMI to the base station in a period equal to the transmission period of the second CSI-RS.

According to an embodiment, the method further comprises: differentiating the first CSI-RS and the second CSI-RS in accordance with configuration information of at least one of the first CSI-RS and the second CSI-RS informed by the base station, wherein the configuration information including one or more of: transmission period, subframe offset, the number of mapped vertical antenna ports and position information of resource.

According to an embodiment, wherein the size of the first codebook is smaller than the size of the second codebook. According to another embodiment, wherein the first PMI is determined on a wideband by the user equipment, and the second PMI is determined on a a wideband or a subband by the user equipment.

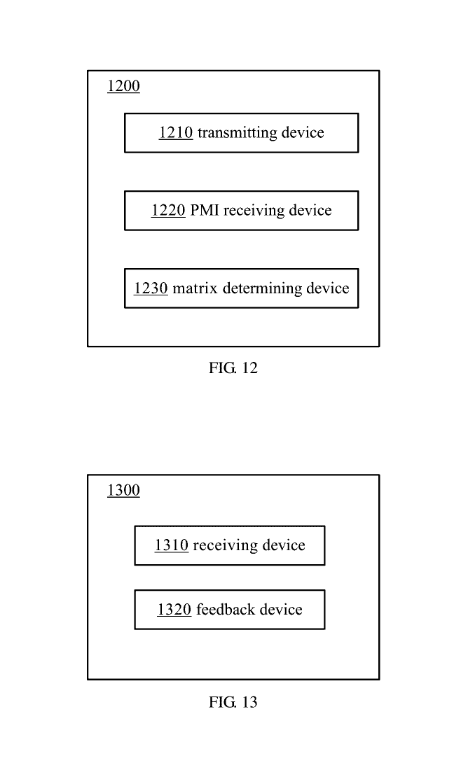

Reference is now made to FIG. 12, which illustrates a block diagram of an apparatus 1200 for channel measurement and feedback according to an embodiment of the present invention. The apparatus 1200 may implement the process of FIG. 1 performed by the base station and the method illustrated in FIG. 10, but is not limited to the process or method. The apparatus may be a base station, Node B, eNode B, or a part thereof.

The apparatus 1200 comprises a transmitting device 1210 for transmitting a first CSI-RS and a second CSI-RS to a user equipment for vertical CSI measurement, wherein the first CSI-RS is based on antenna configuration of one vertical antenna element mapping to one vertical antenna port, and the second CSI-RS is based on antenna configuration of multiple vertical antenna elements mapping to one vertical antenna port. The apparatus 1200 also comprises a PMI receiving device 1220 for receiving at least one PMI, which is fed back by the user equipment in accordance with the first CSI-RS and the second CSI-RS; and a matrix determining device 1230 for determining a vertical precoding matrix for data transmission based on the at least one PMI.

Embodiments of the present invention have also provided apparatuses comprising means for performing each step as illustrated in conjunction with FIG. 10.

Reference is now made to FIG. 13, which illustrates a block diagram of an apparatus 1300 for channel measurement and feedback according to an embodiment of the present invention. The apparatus may perform the process of FIG. 1 performed by the user equipment, but is not limited to the process. The apparatus may be any type of mobile terminal, fixed terminal, portable terminal, or a part thereof, including desktop computer, laptop computer, notebook computer, tablet computer, personal digital assistants (PDAs), audio/video player, digital camera/camcorder, electronic book device, or any combination thereof.

The apparatus 1300 comprises a receiving device 1310 for receiving a first channel state information reference signal (CSI-RS) and a second CSI-RS transmitted by a base station for vertical CSI measurement, wherein the first CSI-RS is based on antenna configuration of one vertical antenna element mapping to one vertical antenna port, and the second CSI-RS is based on antenna configuration of multiple vertical antenna elements mapping to one vertical antenna port. The apparatus 1300 also comprises a feedback device 1320 for feeding back at least one precoding matrix indicator (PMI) to the base station in accordance with the first CSI-RS and the second CSI-RS.

Embodiments of the present invention have also provided apparatuses comprising means for performing each step as illustrated in conjunction with FIG. 11.

Embodiments of the present invention may also be implemented as a computer program product, comprising at least one computer readable storage medium having a computer readable program code portion stored thereon. In such embodiments, the computer readable program code portion comprises at least codes for performing the method for channel measurement and feedback in the base station side or the user equipment side.

Based on the above description, the skilled in the art would appreciate that the present invention may be embodied in an apparatus, a method, or a computer program product. Thus, the present invention may be specifically implemented in the following manners, i.e., complete hardware, complete software (including firmware, resident software, microcode, etc), or a combination of software part and hardware part as generally called “circuit,” “module,” or “system” herein. Further, the present invention may also adopt a form of computer program product as embodied in any tangible medium of expression, the medium comprising computer-usable program code.

Any combination of one or more computer-usable or computer-readable mediums is may be used. The computer-usable or computer-readable medium may be for example, but not limited to, electrical, magnetic, optical, electromagnetic, infrared, or semiconductor system, means, device, or propagation medium. More specific examples (non-exhaustive list) of the computer-readable medium comprise: an electric connection having one or more leads, a portable computer magnetic disk, hard disk, random access memory (RAM), read-only memory (ROM), erasable programmable read-only memory (EPROM or flash), optical fiber, portable compact disk read-only memory (CD-ROM), optical storage device, a transmission medium for example, supporting internet or intranet, or a magnetic storage device. It should be noted that the computer-usable or computer readable medium may even be a paper printed with a program thereon or other suitable medium, because the program may be obtained electronically by electrically scanning such paper or other medium, and then compiled, interpreted or processed in a suitable manner, and if necessary, stored in a computer memory. In the context of the present document, a computer-usable or computer-readable medium may be any medium containing, storing, communicating, propagating, or transmitting a program available for an instruction execution system, apparatus or device, or associated with the instruction execution system, apparatus, or device. A computer-usable medium may comprise a data signal contained in a base band or propagated as a part of carrier and embodying a computer-usable program code. A computer-usable program code may be transmitted by any suitable medium, including, but not limited to, radio, wire, cable, or RF, etc.

A computer program code for executing operations of the present invention may be written by any combination of one or more program design languages, the program design languages including object-oriented program design languages, such as Java, Smalltalk, C++, etc, as well as conventional procedural program design languages, such as “C” program design language or similar program design language. A program code may be completely or partly executed on a user computer, or executed as an independent software package, partly executed on the user computer and partly executed on a remote computer, or completely executed on a remote computer or server. In the latter circumstance, the remote computer may be connected to the user computer through various kinds of networks, including local area network (LAN) or wide area network (WAN), or connected to external computer (for example, by means of an internet service provider via Internet).

Further, each block in the flow charts and/or block diagrams of the present invention and combination of respective blocks therein may be implemented by computer is program instructions. These computer program instructions may be provided to a processor of a general purpose computer, a dedicated computer or other programmable data processing apparatus, thereby generating a machine such that these instructions executed through the computer or other programmable data processing apparatus generate means for implementing functions/operations prescribed in the blocks of the flow charts and/or block diagrams.

These computer program instructions may also be stored in a computer-readable medium capable of instructing the computer or other programmable data processing apparatus to work in a particular manner, such that the instructions stored in the computer-readable medium generate a product including instruction means for implementing the functions/operations prescribed in the flow charts and/or block diagrams.

The computer program instructions may also be loaded on a computer or other programmable data processing apparatus, such that a series of operation steps are implemented on the computer or other programmable data processing apparatus, to generate a computer-implemented process, such that execution of the instructions on the computer or other programmable apparatus provides a process of implementing the functions/operations prescribed in the blocks of the flow charts and/or block diagrams.

Though the exemplary embodiments of the present invention are described herein with reference to the drawings, it should be understood that the present invention is not limited to these accurate embodiments, and a person of normal skill in the art can make various modifications to the embodiments without departing from the scope and principle of the present invention. All such variations and modifications are intended to be included in the scope of the present invention as defined in the appended claims.

1-52. (canceled)

53. A method for channel measurement and feedback, comprising:
transmitting a first channel state information reference signal (CSI-RS) and a second CSI-RS to a user equipment for vertical CSI measurement, wherein the first CSI-RS is based on antenna configuration of one vertical antenna element mapping to one vertical antenna port, and the second CSI-RS is based on antenna configuration of multiple vertical antenna elements mapping to one vertical antenna port;
receiving at least one precoding matrix indicator (PMI), which is fed back by the user equipment in accordance with the first CSI-RS and the second CSI-RS; and
determining a vertical precoding matrix for data transmission based on the at least one PMI.

54. The method of claim 53, wherein transmitting a first CSI-RS and a second CSI-RS to a user equipment including:
transmitting the first CSI-RS to the user equipment in a first period; and
transmitting the second CSI-RS to the user equipment in a second period,
wherein the first period is larger than the second period.

55. The method of claim 53, wherein when the received PMI is a second PMI corresponding to the second CSI-RS and the difference between the first CSI-RS and the second CSI-RS is known to the user equipment, the method further comprises:
receiving an group index of a first PMI in a first codebook fed back by the user equipment and corresponding to the first CSI-RS,
wherein a first codebook corresponding to the first CSI-RS and a second codebook corresponding to the second CSI-RS are divided into a plurality of groups in the same manner.

56. The method of claim 55, wherein determining a vertical precoding matrix for data transmission based on the at least one PMI including:
determining, in a group of the first codebook corresponding to the received group index, a precoding matrix with maximum gain; and
determining the vertical precoding matrix for data transmission by multiplying the determined precoding matrix and a precoding matrix indicated by the second PMI,
wherein the number of mapped vertical antenna ports corresponding to the first PMI is equal to the number of mapped vertical antenna ports corresponding to the second PMI.

57. The method of claim 53, wherein when two PMIs are received, and one of which is a first PMI corresponding to the first CSI-RS and the other is a second PMI corresponding to the second PMI, determining a vertical precoding matrix for data transmission based on the at least one PMI including:
determining the vertical precoding matrix for data transmission based on at least one of the first PMI and the second PMI.

58. The method of claim 57, wherein determining the vertical precoding matrix for data transmission based on at least one of the first PMI and the second PMI including:
determining, in a codebook for data transmission, a precoding matrix with a maximum difference between maximum gains compared to a precoding matrix indicated by the second PMI as the vertical precoding matrix.

59. The method of claim 57, wherein determining the vertical precoding matrix for data transmission based on at least one of the first PMI and the second PMI including:
determining the vertical precoding matrix for data transmission by multiplying a precoding matrix indicated by the first PMI and a precoding matrix indicated by the second PMI,
wherein the number of mapped vertical antenna ports corresponding to the first PMI is equal to the number of mapped vertical antenna ports corresponding to the second PMI.

60. The method of claim 58, wherein when the difference between the first CSI-RS and the second CSI-RS is unknown to the user equipment, the method further comprising:
determining the PMI received in a period equal to the transmission period of the first CSI-RS as the first PMI; and
determining the PMI received in a period equal to the transmission period of the second CSI-RS as the second PMI.

61. The method of claim 53, in order to facilitate the user equipment to acknowledge the difference between the first CSI-RS and the second CSI-RS, the method further comprising:
informing the user equipment configuration information of at least one of the first CSI-RS and the second CSI-RS,
wherein the configuration information including one or more of: transmission period, subframe offset, the number of mapped vertical antenna ports, and position information of resource.

62. A method for channel measurement and feedback, comprising:
receiving a first channel state information reference signal (CSI-RS) and a second CSI-RS transmitted by a base station for vertical CSI measurement, wherein the first CSI-RS is based on antenna configuration of one vertical antenna element mapping to one vertical antenna port, and the second CSI-RS is based on antenna configuration of multiple vertical antenna elements mapping to one vertical antenna port; and
feeding back at least one precoding matrix indicator (PMI) to the base station in accordance with the first CSI-RS and the second CSI-RS.

63. The method of claim 62, wherein receiving a first CSI-RS and a second CSI-RS transmitted by a base station including:
receiving the first CSI-RS transmitted by the base station in a first period; and
receiving the second CSI-RS transmitted by the base station in a second period,
wherein the first period is larger than the second period.

64. The method of claim 62, wherein when the difference between the first CSI-RS and the second CSI-RS is known to the user equipment, feeding back at least one PMI to the base station in accordance with the first CSI-RS and the second CSI-RS including:
determining a first PMI in a first codebook in accordance with the first CSI-RS;
determining a second PMI in a second codebook in accordance with the second CSI-RS;
determining a third PMI based on at least one of the first PMI and the second PMI; and
feeding back the third PMI to the base station.

65. The method of claim 64, wherein determining a third PMI based on at least one of the first PMI and the second PMI including:
determining an group index corresponding to the first PMI in the first codebook;
determining, in a group of the second codebook corresponding to the determined group index, an angel with the maximum gain in a precoding matrix indicated by the second PMI; and
determining the third PMI in a codebook for data transmission based on the determined angel,
wherein the first codebook and the second codebook are divided into a plurality of groups in the same manner.

66. The method of claim 64, wherein determining a third PMI based on at least one of the first PMI and the second PMI including:
determining, in a codebook for data transmission, a PMI corresponding to a precoding matrix with a maximum difference between maximum gains compared to a precoding matrix indicated by the second PMI as the third PMI.

67. The method of claim 62, wherein when the difference between the first CSI-RS and the second CSI-RS is known to the user equipment, feeding back at least one PMI to the base station in accordance with the first CSI-RS and the second CSI-RS including:
determining a first PMI in a first codebook in accordance with the first CSI-RS;
determining an group index corresponding to the first PMI in the first codebook;
determining, in a group of a second codebook corresponding to the determined group index, a second PMI in accordance with the second CSI-RS; and
feeding back the second PMI and the group index corresponding to the first PMI to the base station,
wherein the first codebook and the second codebook are divided into a plurality of groups in the same manner.

68. The method of claim 62, wherein feeding back at least one PMI to the base station in accordance with the first CSI-RS and the second CSI-RS including:
determining a first PMI in a first codebook in accordance with the first CSI-RS;
determining a second PMI in a second codebook in accordance with the second CSI-RS; and
feeding back the first PMI and the second PMI to the base station.

69. The method of claim 68, wherein when the difference between the first CSI-RS and the second CSI-RS is unknown to the user equipment, and the first codebook is the same to the second codebook, feeding back the first PMI and the second PMI to the base station including:
feeding back the first PMI to the base station in a period equal to the transmission period of the first CSI-RS; and
feeding back the second PMI to the base station in a period equal to the transmission period of the second CSI-RS.

70. The method of claim 62, further comprising:
differentiating the first CSI-RS and the second CSI-RS in accordance with configuration information of at least one of the first CSI-RS and the second CSI-RS informed by the base station,
wherein the configuration information including one or more of: transmission period, subframe offset, the number of mapped vertical antenna ports and position information of resource.

71. An apparatus for channel measurement and feedback, comprising:
a transmitting device for transmitting a first channel state information reference signal (CSI-RS) and a second CSI-RS to a user equipment for vertical CSI measurement, wherein the first CSI-RS is based on antenna configuration of one vertical antenna element mapping to one vertical antenna port, and the second CSI-RS is based on antenna configuration of multiple vertical antenna elements mapping to one vertical antenna port;
a PMI receiving device for receiving at least one precoding matrix indicator (PMI), which is fed back by the user equipment in accordance with the first CSI-RS and the second CSI-RS; and
a matrix determining device for determining a vertical precoding matrix for data transmission based on the at least one PMI.

72. An apparatus for channel measurement and feedback, comprising:
a receiving device for receiving a first channel state information reference signal (CSI-RS) and a second CSI-RS transmitted by a base station for vertical CSI measurement, wherein the first CSI-RS is based on antenna configuration of one vertical antenna element mapping to one vertical antenna port, and the second CSI-RS is based on antenna configuration of multiple vertical antenna elements mapping to one vertical antenna port; and
a feedback device for feeding back at least one precoding matrix indicator (PMI) to the base station in accordance with the first CSI-RS and the second CSI-RS.
